(19) United States
(12) Patent Application Publication
(10) Pub. No.: US 2020/0318710 A1
(43) Pub. Date: Oct. 8, 2020

(54) Temporarily Condensed Shaft Damper

(71) Applicant: UFP Technologies, Inc., Newburyport, MA (US)

(72) Inventors: Jason D. Holt, Flower Mound, TX (US); Matthew Robert Hale, Marne, MI (US); William J. Schnell, Middleville, MI (US); Lawrence W. Barrows, Kenai, AK (US); Daniel J. Shaw, Jr., Groveland, MA (US)

(73) Assignee: UFP Technologies, Inc., Newburyport, MA (US)

(21) Appl. No.: 16/839,234

(22) Filed: Apr. 3, 2020

Related U.S. Application Data
(60) Provisional application No. 62/828,605, filed on Apr. 3, 2019.

(51) Int. Cl. F16F 15/10; F16C 3/02

(52) U.S. Cl. CPC F16F 15/10; F16C 3/02; F16C 2226/12; F16F 2234/02; F16C 2326/06; F16F 2222/08; F16F 2226/04; F16F 2224/0225

(57) ABSTRACT

The present invention consists of providing a drive shaft damper having a condensed radial size of most of the shaft damper insert along its length for the purposes of lowering the cost of freight and enabling easy installation of the product into the drive shaft. Parts can be inserted into a drive shaft without any radial interference, which then can expand after installation. End portions may have radial interference without compression or with minimal compression to seal the damper.

### RELATED APPLICATIONS

This application claims priority to and the benefit of U.S. Provisional Patent Application No. 62/828,605, filed on Apr. 3, 2019, the entire contents of which are hereby incorporated by reference.

### FIELD OF THE DISCLOSURE

The disclosure generally relates to a drive shaft damper structure. More specifically, this disclosure relates to condensing the radial size of a shaft damper insert.

### BACKGROUND AND SUMMARY

Many automotive vehicles, particularly heavy duty vehicles such as the Ford F150 and 250, Chevy/GMC Silverado/Sierra and Topkick/Kodiac Light and Heavy Duty models, Nissan Titan and other older vehicle programs, conventionally utilize hollow, tubular drive or propeller shafts for transmitting driving torque from the engine to the driving wheels. It is not uncommon for such a shaft to be subjected to vibrations from one or more sources. It is desirable to damp such vibrations so as to provide a quieter and smoother vehicle.

The prior art slides a substantially cylindrical damper into a hollow drive shaft from one end. The damper is made of materials that damp the vibrations and attenuate noise. Examples of such dampers are disclosed in U.S. Pat. Nos. 5,976,021; 4,909,361; 4,014,184; 3,075,406; 2,751,765; and 5,868,627, which are incorporated here by reference as background disclosure.

Previously, as shown in FIG. 2, shaft damper inserts were created to be press fit into an interior chamber of a drive shaft. The press fit would extend for substantially the entire length of the damper insert. The nature of the press fit operation limited the number of types of foam that could be used to make the damper insert and also usually needs a jig to pull the damper into position which requires openings at both ends of the drive shaft.

The present invention consists of providing a drive shaft damper insert having a condensed radial size of most of the shaft damper insert along its length for the purposes of lowering the cost of freight and enabling easy installation of the product into the shaft. Parts can be inserted into a drive shaft without any radial interference, but preferably may have at least one end portion having radial interference. This makes the process faster, less capital intensive, still provide a seal at one or both ends as needed, and produces less scrap.

Designs also can take advantage of foams that might not otherwise be available to be used due to the current press fit insertion method that requires a certain functionality to the foam.

By reducing the radial dimension, parts can also be packed in a significantly reduced footprint to not only save freight cost, but also reduce the storage footprint at both the supplier (or manufacturer) and customer level.

### BRIEF SUMMARY OF THE DRAWINGS

FIG. 1 is an elevational perspective view of a foam damper used in the prior art but about to be processed in the present invention via a cellophane wrap;

FIG. 2 is a schematic view, partially in section, of the prior art press fit drive shaft damper or isolator product;

FIG. 3 is a schematic view, partially in section, or the prior art press fit drive shaft isolator product of the present invention;

FIGS. 4A and 4B are elevational perspective views of two versions of the present invention, one (4B) having a radially expanded head at one end, and the second (4A) having radially expanded heads at both ends of the drive shaft damper; and

FIG. 5 is a schematic illustrating the radial reduction on the inner section product of the present invention prior to expansion.

### DETAILED DESCRIPTION OF THE DISCLOSURE

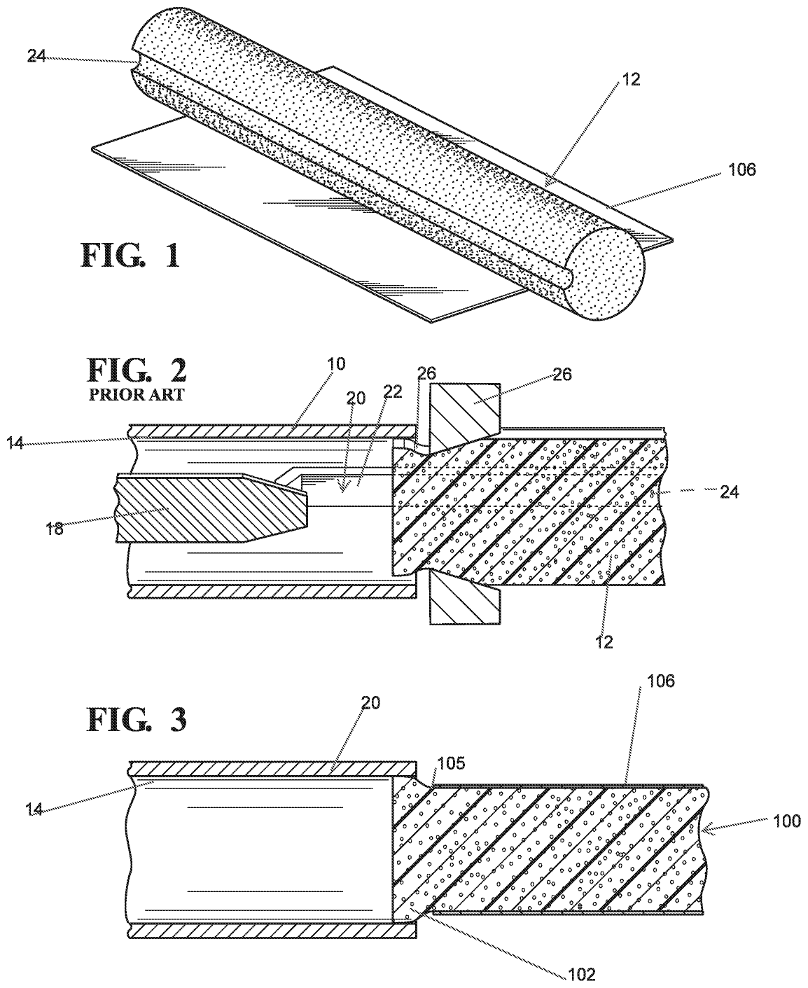

FIG. 2 illustrates the prior art damper process used with a tubular drive or propeller shaft 10. A damper 12 can be inserted into the inner chamber 14 of the shaft 10. The inner chamber is usually a cylindrical configuration. An installation device 16 is used to insert the damper 12 into the chamber 14 of the shaft 10. The device 16 has an elongated primary element 18 which is attached to a flat elongated secondary element 20, both of which can be inserted through the chamber 14 of the shaft 10. The secondary element 20 has an extended flat portion 22 that fits within an elongated indentation 24 in the damper 12, shown in FIG. 1. The flat portion 22 extends the length of the damper 12 with an end portion that captures the end of the damper 12 (not shown) in a manner to permit the damper 12 to be pulled axially when the flat portion 22 is pulled along the axis of the chamber 14. In addition to pulling the damper 12 into the chamber 14, the damper 12 is pulled through a compression die 26 to compress the damper to a size less than or approximately equal to the diameter of the chamber 14 to facilitate the installation of the damper 12 into the chamber 14 of the shaft 10 via a press fit along the full length of the damper 12 once installed in the shaft 10. The damper 12 is usually constructed of a material or a combination of materials that ultimately allows the damper 12 to return to its pre-installation size once is it installed into the shaft 10 to dampen vibrations in the shaft 10.

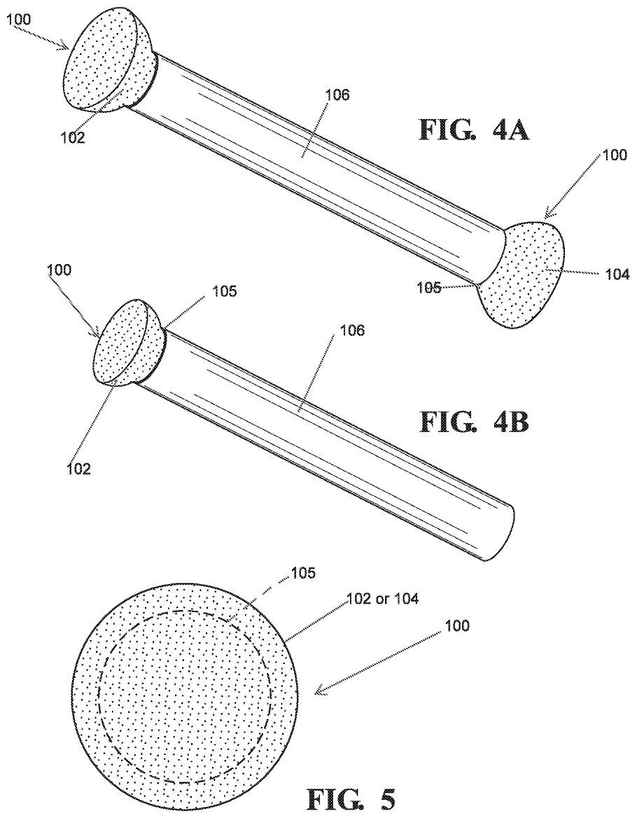

Instead of a complete press fit of the drive shaft insert 12 in the drive shaft 10 of FIG. 2 as in the prior art, the present invention, as illustrated in FIGS. 3, 4A and/or 4B, reduces the radial dimension of the damper or insert 100 except at the end portions 102 and/or 104. The radial dimension of the damper 100 is reduced by means of a cellophane wrap 106 (also shown unwrapped in FIG. 1). The wrap 106 is usually shrink wrapped and compresses the foam damper 100 usually prior to shipment, and forms either one or two end portions 102 and/or 104 after the damper 100 is wrapped up to edges 105. When wrapped prior to shipment, more dampers 100 can be shipped in one container because the volume is smaller than prior to wrapping. The usual determination of whether or not one or two end portions 102, 104 is formed is based upon whether the chamber 14 of the shaft 10 is open at two ends (where two ends are needed to seal both ends of the shaft 10) or one end (where only one end of the shaft 10 needs to be sealed), or possibly other concerns.

The end portions 102, 104 can be installed into the drive shaft 20 without any pulling equipment once the cellophane wrap 106 is taken off of the damper 100. The wrap is removed by cutting it with a sharp object and removing it. The damper 100 is formed of a foam material that will expand to the original pre-wrapped (pre-compressed) shape of the damper 100 (as shown in FIG. 1) but not immediately (delayed), and can use various of a variety of foam materials with more or less rebound from compression as needed if more or less time is needed. The relatively small axial dimension of the end portions 102 and/or 104 permit the leading end portion of the damper 100 to pass through the length of the chamber 14 of the shaft 10 with very little force needed and seal the open end or ends of the chamber 14. Once it is installed in the chamber 14 of the shaft 10, the foam will return to its pre-compressed volume and fill the space of the chamber 14 as well as further seal the end or ends of the chamber.

As shown in FIG. 5, the radial dimension can be reduced significantly at all dimensions along the length of the insert. The end portions 102 and/or 104 would retain a dimension to be press fit into the interior of the drive shaft. But from a time standpoint, the amount of assembly time is dramatically shorter and less needed force due to much less friction opposing the insertion of the damper 100. Damper diameter ranges to correspond with existing shafts range from three to seven inches in the non-compressed state and one to three inches in the compressed state. Materials such as CV35123 (1.15-1.28 density foam), 1255HMFC9 (1.20-1.35 density foam), A123-3200 (1.18-1.44 density foam), CV28145 (1.40-1.50 density foam), AB40-140 (1.40-1.75 density foam), A155-42EO (1.45-1.73 density foam), and 1.85 NAESUL (1.75-2.05 density foam) are materials in pounds per cubic foot density that have been found to satisfy the requirements of the invention for various parts as designed by the ultimate customer including a satisfactory amount of delay time from unwrapping the wrap through installation in the chamber. As described, a full array of foam products can be used for the insert. This array of materials can be used, as well as other even lighter and more flexible materials to increase the design options for dampers 100 in future products, even many choices of materials that cannot be used with the current prior art process or product on FIG. 2.

Several embodiments have been discussed in the foregoing description. However, the embodiments discussed herein are not intended to be exhaustive or limit the invention to any particular form. The terminology which has been used is intended to be in the nature of words of description rather than of limitation. Many modifications and variations are possible in light of the above teachings and the invention may be practiced otherwise than as specifically described.

What is claimed is:

1. A damper for use in a hollow, cylindrical member having an inner chamber of predetermined diameter, said damper comprising a cylindrical insert formed of resiliently deformable material having an outer diameter of such dimension as snugly to be accommodated in the chamber; and at least one seal disposed relative to at least one end of said insert, said seal comprising a diameter of said body having a cylindrical wall concentric with said insert and extending axially thereof, and an axially extending reduced diameter portion of the insert having a wrap to maintain said reduced diameter along the length of the wrap, wherein the reduced diameter of said insert expands once the wrap is removed and the insert is disposed in said chamber.

2. A damper in accordance with claim 1, wherein said chamber has two open ends and a seal is disposed at each end of said chamber when said insert is disposed in the chamber.

3. A damper in accordance with claim 1, wherein the insert is manufactured with compressible foam material.

4. A damper in accordance with claim 2, wherein said foam material has a foam density in the range of 1.15 to 2.05 pounds per cubic foot density.

5. A damper in accordance with claim 1, wherein said insert has an undeformed diameter greater than that of the chamber diameter.

6. A damper insert for use in a hollow, cylindrical member having an inner chamber of predetermined diameter, said drive shaft damper insert having an axial length and defining a reduced radial portion along its length formed of resiliently deformable material having an outer diameter of such dimension as snugly to be accommodated in the chamber cylindrical liner for accommodation into said cylindrical member; and a wrap to reduce an axially intermediate section of said insert, wherein the wrap is removeable to permit said intermediate section to expand to a full radial dimension to conform snugly with said inner chamber.

7. A damper insert in accordance with claim 6, wherein said insert comprises foam selected from a density range from 1.15 to 2.05 pounds per cubic foot density.

8. A damper insert in accordance with claim 6, wherein said chamber has two open ends and said insert has a seal at each end.

9. A damper insert in accordance with claim 6, wherein said chamber has one open end and said insert has a seal at said one open end.

10. A method of producing an expandable, cylindrical insert adapted for accommodation in a hollow, cylindrical chamber of a drive shaft having at least at one end opening, said method comprising manufacturing said insert from a resiliently compressible material; placing a wrap on an axially intermediate section of said insert, removing the wrap, placing the insert into said chamber, and permitting the expansion of said insert to snugly conform with said chamber.

11. A system for using a cylindrical drive shaft insert producing an expandable, cylindrical insert adapted for accommodation in a hollow, cylindrical chamber of a drive shaft having two one end openings, comprising manufacturing said insert from a resiliently compressible material that returns to shape with a delayed response; placing a wrap on an axially intermediate section of said insert to produce a reduced diameter section; removing the wrap; placing said insert into said chamber, and permitting the expansion of said intermediate section of said insert to snugly conform with said chamber.
